(19) United States
(12) Patent Application Publication
(10) Pub. No.: US 2009/0024479 A1
(43) Pub. Date: Jan. 22, 2009

(54) COMMUNITY-BASED RECYCLING SYSTEM AND METHODS THEREOF

(75) Inventors: Ron Gonen, New York, NY (US); Frank C. Yang, Framingham, MA (US); Bob Milligan, Kintersville, PA (US); Scott Lamb, Brewyn, PA (US)

Correspondence Address: MALDJIAN & FALLON LLC, 365 BROAD ST. , 3RD FLOOR, RED BANK, NJ, 07701, US

(73) Assignee: RecycleBank LLC, Philadelphia, PA (US)

(21) Appl. No.: 12/200,527

(22) Filed: Aug. 28, 2008

Related U.S. Application Data
(63) Continuation-in-part of application No. 11/345,867, filed on Feb. 2, 2006.
Application No. 11/345,867 is a continuation-in-part of application No. 11/854,387, filed on Sep. 12, 2007.
(60) Provisional application No. 60/650,610, filed on Feb. 7, 2005.
(60) Provisional application No. 60/968,683, filed on Aug. 29, 2007.

(51) Int. Cl. G06Q 30/00

(52) U.S. Cl. 705/14

(57) ABSTRACT

Embodiments of the present invention generally relate to a community-based recycling system and methods of utilizing same. In one embodiment of the present invention, a community-based recycling system comprises a first entity, providing recyclable material, a second entity, providing recyclable material, a load determining device for obtaining a qualitative or quantitative measurement of the recyclable material accumulated from both the first entity and the second entity, and a reward granted equally to each of the first entity and the second entity, wherein the reward corresponds to a value generated from the measurement of the recyclable material.

### CROSS-REFERENCE TO RELATED APPLICATIONS

This application is a continuation-in-part of U.S. patent application Ser. No. 11/345,867, filed Feb. 2, 2006, which claims the benefit of U.S. Provisional Patent Application Ser. No. 60/650,610, filed Feb. 7, 2005, the disclosures of which are incorporated herein by reference in their entireties. This application is also a continuation-in-part of U.S. patent application Ser. No. 11/854,387, filed Sep. 12, 2007, the disclosure of which is incorporated herein by reference in its entirety. This application also claims the benefit of U.S. Provisional Patent Application Ser. No. 60/968,683, filed Aug. 29, 2007, the disclosure of which is incorporated herein by reference in its entirety.

### BACKGROUND OF THE INVENTION

1. Field of the Invention

Embodiments of the present invention generally relate to an incentive based recycling system and method thereof. More specifically, embodiments of the present invention relate to a community-based recycling system and methods of utilizing same.

2. Description of the Related Art

Over the past few decades, costs for collecting and disposing waste material (“waste”) have skyrocketed. Decreases in available landfill capacity have caused the cost associated with disposing of waste in such landfills to increase. Adding to these costs are governmental (e.g., federal, state and local) landfill taxes, which have also increased sharply over the past few decades.

Even where landfill capacity exists, the cost associated with potential and actual environmental hazards associated with landfill operation are likewise increasing. These costs can include, for example, losses of valuable property and environmental cleanup costs for rehabilitating landfills and surrounding areas that become contaminated with dangerous chemicals due to the disposal and decomposition of the waste. Given the financial and environmental burdens associated with the collection and disposal of waste, municipalities have actively pursued recycling as an alternative to disposal.

Fortunately, demand for recyclable material has increased as a result of expansion in manufacturing. Manufacturers have long recognized that manufacturing goods from recyclable material is less costly than manufacturing such goods from virgin material due to, for example, the costs associated with extracting and processing the virgin material into useable form.

Advances in Single Stream Recycling (SSR) technology reduce the cost of recycling. In addition, recent improvements in automated separation of comingled recyclable material at processing centers have dramatically reduced the cost of collecting, sorting, and processing the recyclable material. The combination of the SSR technology and automated separation enables an automated process to separate and process comingled recyclable material (for example, cardboard, paper, plastic, glass and aluminum material). This combination enables and permits processing centers to cut costs (e.g., reduce labor costs and sorting time) by using an automated process, as opposed to manual labor, to separate the recyclables. In addition, the combination enables municipalities to cut cost of collection by collecting the recyclable material in comingled form.

While information-technology tools have revolutionized the way many governments and industries operate, the waste management industry has not embraced information technology in the same way. As such, the waste management industry lacks modern, up-to-date information technology tools for efficiently carrying out business management, operations management and other activities associated with recycling (collectively “recycling activities”). In turn, the lack of information-technology tools has limited municipalities and/or other entities administering recycling programs to provide incentives for entities, such as business, governments and households, to recycle, to design effective strategies for recycling, to measure performance against such recycling strategies, and the like.

Recycling reduces the financial and environmental burdens of waste disposal, reduces energy costs, and conserves our environments resources. Therefore, there is a need to establish recycling initiatives that recognize the existing problems associated with the disposal of waste and promote recycling efforts as part of a waste management program.

### SUMMARY

Embodiments of the present invention generally relate to a community-based recycling system and methods of utilizing same. In one embodiment of the present invention, a community-based recycling system comprises a first entity, providing recyclable material, a second entity, providing recyclable material, a load determining device for obtaining a qualitative or quantitative measurement of the recyclable material accumulated from both the first entity and the second entity, and a reward granted equally to each of the first entity and the second entity, wherein the reward corresponds to a value generated from the measurement of the recyclable material.

In another embodiment, a recycling system comprises a first entity, providing a quantity of recyclable materials, a second entity, providing a quantity of recyclable materials, a community container for supporting a quantity of recyclable materials received from the first and second entities, a collection vehicle for collecting recyclable materials from the first and second entities, comprising a load determining device for obtaining at least a weight or volume of the recyclable materials, and an identification means, and a reward granted equally to each of the first entity and the second entity, wherein the reward corresponds to a value generated from the weight or volume of the recyclable material.

In yet another embodiment, a community-based method of recycling comprises collecting recyclable material from an identifiable first entity, collecting recyclable material from an identifiable second entity, obtaining a qualitative or quantitative measurement of cumulative recyclable materials collected from both the first and second entities, calculating a value associated with the qualitative or quantitative measurement of cumulative recyclable materials, and granting a reward to the first and second entities based on the value.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a block diagram of a general computer system in accordance with one embodiment of the present invention;

FIG. 2 depicts an exemplary system for recycling recyclable material in accordance with one embodiment of the present invention;

FIG. 3 depicts an exemplary recycling system, in accordance with one embodiment of the present invention; and

FIG. 4 is a block diagram of the method of recycling in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present invention generally relate to an incentive based recycling system and method thereof. More specifically, embodiments of the present invention relate to a community-based recycling system and methods of utilizing same.

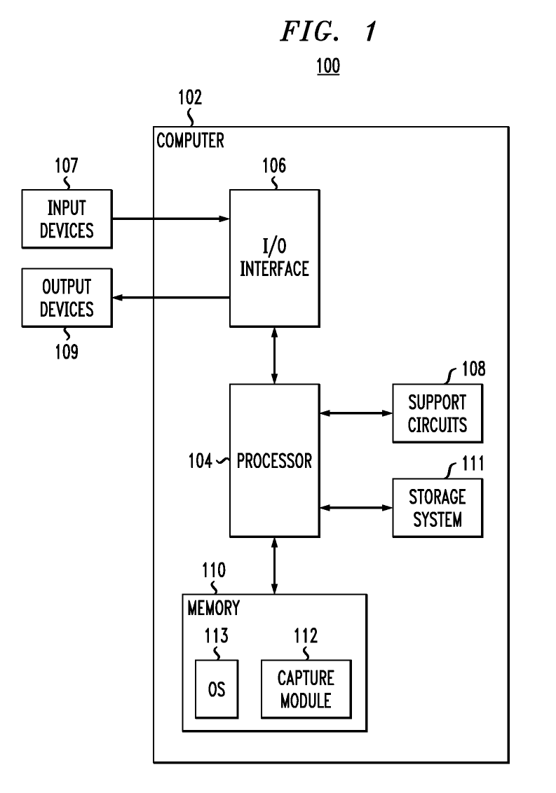

FIG. 1 depicts a block diagram of a general computer system in accordance with one embodiment of the present invention. The computer system 100 generally comprises a computer 102. The computer 102 illustratively comprises a processor 104, a memory 110, various support circuits 108, and I/O interface 106, and a storage system 111. The processor 104 may include one or more microprocessors. The support circuits 108 for the processor 104 include conventional cache, power supplies, clock circuits, data registers, I/O interfaces, and the like. The I/O interface 106 may be directly coupled to the memory 110 or coupled through the processor 104. The I/O interface 106 may also be configured for communication with input devices 107 and/or output devices 109, such as network devices, various storage devices, mouse, keyboard, display, and the like. The storage system 111 may comprise any type of block-based storage device or devices, such as a disk drive system.

The memory 110 stores processor-executable instructions and data that may be executed by and used by the processor 104. These processor-executable instructions may comprise hardware, firmware, software, and the like, or some combination thereof. Modules having processor-executable instructions that are stored in the memory 110 may include a capture module 112. The computer 102 may be programmed with an operating system 113, which may include OS/2, Java Virtual Machine, Linux, Solaris, Unix, HPUX, AIX, Windows, MacOS, among other platforms. At least a portion of the operating system 113 may be stored in the memory 110. The memory 110 may include one or more of the following: random access memory, read only memory, magneto-resistive read/write memory, optical read/write memory, cache memory, magnetic read/write memory, and the like.

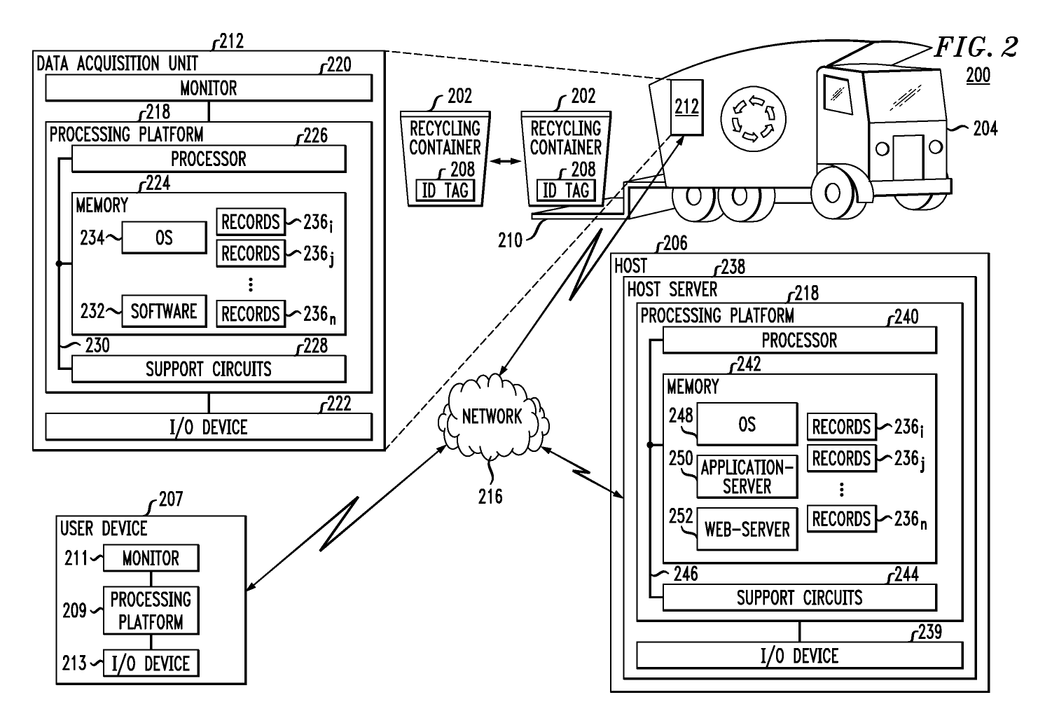

FIG. 2 depicts an exemplary system for recycling recyclable material in accordance with one embodiment of the present invention. The system includes recycling container 202, a collection vehicle 204, a host 206 and a user device 207.

The recycling container 202 is adapted to accept recyclable material deposited by an entity (“deposited material”) for collection. The deposited material may include one type of or any combination of types of recyclable material, including, for example, cardboard, paper, plastic, glass, aluminum, organic, or any other material not suitable for landfills. The recycling container 202 may be of any shape or size so long as it is adapted to hold a quantifiable measure of the deposited material. The recycling container 202 may be provided to an entity for a fee (e.g., a one-time, fixed, rental, deposit, or other type of fee) or for free (e.g., on loan or given outright).

The recycling container 202 includes an identification tag 208 for identifying the recycling container 202. The identification tag 208 may be used to track each collection of the deposited material. The identification tag 208 may be machine-readable device, such as a bar-code label, a magnetic-strip device, a radio-frequency-identification (“RFID”) tag and the like; and may include and/or be programmed with information for identifying the recycling container 202, and in turn, information (e.g., an address, an account, etc.) associated with the entity (“entity information”).

The identification tag 208 may also be a non-machine readable label or other non-machine readable device. As such, the identification tag 208 may include an identifier that can be transferred to (e.g., manually entered into) the host 206, which in turn, uses the identifier to obtain information stored thereon for identifying the recycling container 202 and the entity information.

The collection vehicle 204 may be any device or system capable of collecting recyclable material. The collection vehicle 204 may be automobile or truck, as shown in FIG. 2. Additionally, the collection vehicle 204 may be an interactive terminal (i.e., a kiosk) adapted to receive the recyclable materials from the recycling container 202, or a processing center capable of receiving recyclable materials. The collection vehicle 204 may include a load determining device 210 and a data acquisition unit 212. The load determining device 210 may include any of, any multiple of, any combination of or any combination of multiples of a scale, load cell, load-cell system, a counting device and/or system or other measuring apparatus or system for (i) determining a quantifiable measure (e.g., weight, quantity, etc.) of the deposited material and/or (ii) transferring such quantifiable measure (“deposited-material measure”) to the data-acquisition unit 212 for storage and/or subsequent processing.

In many embodiments, the load determining device 210 determines a quantifiable measure as a function of weight measurements from at least one recycling container 202 obtained before and after the deposited material is transferred to the collection vehicle 204. The load determining device 210 may also determine the deposited-material measure as a function of quantities of the deposited material in recycling container 202 before and after such material are transferred to the collection vehicle 204. The load determining device 210 may determine the deposited-material measure in other ways as well. In one embodiment, the load determining device 210 determines a collective quantifiable measure of a plurality of deposited material from a plurality of recycling containers 202 obtained from a plurality of entities.

Some or the entire load determining device 210 may be coupled (e.g., affixed or removably attached) to the collection vehicle 204. For example, all or portions of the load determining device 210 may be coupled to a rear end of an automobile collection vehicle 204. Additionally, a load determining device 210 may be coupled to a base of a kiosk, or be integral with a processing center. Also, all or portions of the load determining device 210 may be removably attached to the collection vehicle 204.

The data-acquisition unit 212 and host 206 may communicatively coupled together via a link or network (collectively “network”) 216. This way, the data-acquisition unit 212 and host 206 may exchange information via one or more communications carried over the network 216.

The network 216 may be a partial or full deployment of most any communication/computer network or link, including any of, any multiple of, any combination of or any combination of multiples of a public or private, terrestrial wireless or satellite, and wireline networks or links. The network 216 may include, for example, network elements from a Public Switch Telephone Network (“PSTN”), the Internet, core and proprietary public networks, wireless voice and packet-data networks, such as 1G, 2G, 2.5G and 3G telecommunication networks, wireless office telephone systems (“WOTS”) and/or wireless local area networks (“WLANs”), including, Bluetooth and/or IEEE 802.11 WLANs, wireless personal area networks (“WPANs”), wireless metropolitan area networks (“WMANs”) and the like; and/or communication links, such as Universal Serial Bus (“USB”) links; parallel port links, Firewire links, RS-232 links, RS-485 links, Controller-Area Network (“CAN”) links, and the like.

The network elements and/or communication links may include circuit-switched as well as packet-data elements to provide transport of content, triggers and/or other information; and may be configured to communicate such information using any number of protocols and in any manner consistent with exchanging such information among data-acquisition unit 212 and host 206. These protocols may include standardized, proprietary, open-source, and freely-available communication protocols for communicating content in circuit-switching and/or packet data networks, and the like.

The data acquisition unit 212 may be, for example, any of or any combination of a general computer (for example, the computer of FIG. 1); personal computer; a portable computer, a handheld computer; a mobile phone, a digital assistant, a personal digital assistant, a cellular phone, a smart phone, a pager, a digital tablet, a laptop computer, an Internet appliance and the like. In general, the data acquisition unit 212 includes a processor-based platform that operates on any suitable operating system, such as Microsoft® Windows®, Linux and/or Symbian; and that is capable of executing software.

Additionally, the data acquisition unit 212 may be formed in a single unitary device and concentrated on a single server, client, peer or other type node. Alternatively, the data acquisition unit 212 may be formed from one or more separate devices, and as such, may be distributed among a number of server, client, peer or other type nodes. The data acquisition unit 212 may also be scalable (i.e., may employ scale-up and/or scale-out approaches).

The data acquisition unit 212 may include a large number of elements; most of which are not shown in FIG. 2 for simplicity of exposition. As shown, the data acquisition unit 212 includes a processing platform 218 that is operable to control, manipulate or otherwise interact with a monitor 220 or other display device (collectively “monitor”) and/or an input/output (“I/O”) device 222, via respective couplings.

The monitor 220 may be any suitable device that displays viewable images and/or text generated by the processing platform 218. For instance, the monitor 220 may be any of or any combination of a liquid-crystal-display based monitor, a cathode ray tube monitor, a plasma display monitor, a surface-conduction electron-emitter display monitor, an organic light-emitting diode display monitor, or any other monitor that can display viewable images using television and/or computer protocols, such as Super Video Graphics Array, Digital Visual Interface, Phase Alternating Line, SECAM, NTSC, etc.

The I/O device 222 may be any device that accepts input from a user (man or machine) to control, manipulate or otherwise interact with the operation of the processing platform 218. In addition, the I/O device 222 may be adapted to obtain from the identification tag 208 the entity information and/or identifier that identifies the recycling container 202. Examples of the I/O device 220 include any of or any combination of pointing device, such as a mouse, joystick, trackball, touchpad, pointing stick, light pen, head pointer, soap mouse, eye tracking devices, digitizing tablet and stylus, data glove that translates the user's movements to computer gestures; and a key-in device, such as a keyboard or a touchpad; a reader, such as a bar-code reader, a magnetic-strip reader, a RFID reader, and the like. Although shown as a single device, the I/O device 222 may be separated into two or more devices; each of which may have, as compared to the I/O device 222, reduced, increased or equivalent functionality. In addition, the I/O device 222 and the monitor 220 may be integrated or otherwise combined together in a single device and/or housing.

The processing platform 218 includes memory 224, one or more processors (collectively “processor”) 226, supports circuits 228 and bus 230. The memory 224 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like.

The memory 224 may store and/or receive requests from the processor 226 to execute software 232, such as operating system 234. Additionally, the memory 224 may store and/or receive requests from the processor 226 to obtain (i) operands, operators, dimensional values, configurations, and other data that are used by the operating system 234 and the software 232 to control the operation of and/or to facilitate performing the functions of the data acquisition unit 212; and/or (ii) one or more records or other data structures (collectively, “records”) 236.sub.i-236.sub.n.

Each of the records 236.sub.i-236.sub.n may be stored as or in a single file or a plurality of files, and may be structured as text, a table, a database, a distributed hash table, a distributed concurrent object store, a document formed using a markup or markup-like language, and the like. The records 236.sub.i-236.sub.n may include, for example, a deposited-material record 236.sub.j. The deposited-material record 236.sub.j may store, be populated with or otherwise adapted to hold the deposited-material measure as determined by the load determining device 210.

The processor 226 may execute (e.g., launch, generate, run, maintain, etc.) and/or operate on the operating system (“OS”) 234. The processor 226 may be capable of (i) executing the software 232; (ii) storing the records 236.sub.i-236.sub.n in the memory 224; (iii) dispatching to the host 206 the records 236.sub.i-236.sub.n (including the deposited-material record 236.sub.j) for further processing; (iv) issuing triggers and/or (v) issuing one or more commands and/or instructions to cause the further processing of records 236.sub.i-236.sub.n. Examples of the processor 226 include conventional processors, microprocessors, multi-core processors, microcontrollers and the like.

The support circuits 228 facilitate operation of the processor 226 and may include well-known circuitry or circuits, including, for example, an I/O interface; one or more network-interface units (“NIUs”); cache; clock circuits; power supplies; and the like. The NIUs may be adapted for communicating over any of, any multiple of, any combination of or any combination of multiples of terrestrial wireless, satellite, and/or wireline media. The processor 226 (and in turn, the data-acquisition unit 212) may use the NIUs for exchanging content with the host 206 via network 216.

The bus 230 provides for transmissions of digital information among the processor 226, the memory 224, support circuits 228 and other portions of the data acquisition unit 212 (shown and not shown). The I/O interface is adapted to control transmissions of digital information between (shown and not shown) components of the data acquisition unit 212. In addition, the I/O interface is adapted to control transmissions of digital information between I/O devices disposed within, associated with or otherwise attached to the data acquisition unit 212. Examples of the I/O devices include the I/O device 222, the monitor 220, and any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) the like.

The operating system 234 may include code for operating the data acquisition unit 212 and for providing a platform onto which the software 232 can be executed. The software 232 may include data-acquisition software, which may carry out the acquisition of and storage of the deposited-material measure into the deposited-material record 236.sub.j. The data-acquisition software may also communicate the deposited-material record 236.sub.j to the host 206 using, for example, the communication and/or security protocols compatible with the data acquisition unit 212 and the host 206. To facilitate this, the data-acquisition software may include code to allow the data-acquisition software (and/or the data acquisition unit 212) to substantiate its identity, and in turn, receive authorization to access (e.g., view, configure, use and/or execute) services of the host 206.

The host 206 may include one or more servers, including a host server 238. The host server 238 may be deployed in one or more general or specialty purpose computers, personal computers, mainframes, minicomputers, server-type computers and/or any a processor-based platform that operates on any suitable operating system, such as Microsoft® Windows® and/or Linux; and that is capable of executing software.

Like the data acquisition unit 212, the host server 238 may include a large number of elements; most of which are not shown in FIG. 1 for simplicity of exposition. The elements of host server 238 may be formed in a single unitary device and concentrated on a single server, client, peer or other type node. Alternatively, the elements of the host server 238 may be formed from two or more separate devices, and as such, may be distributed among a number of server, client, peer or other type nodes.

The host server 238 may be deployed in accordance with the scale-up and/or scale-out approaches. Using the scale-up approach, the host server 238 may increase its processing power, amount of memory and number of networkable connections by utilizing a symmetrical, multi-processor architecture so as to provide additional capacity. A benefit of this scale-up approach is that such approach provides for simplified configuration and management as compared to the scale-out approach. Using the scale-out approach, the host server 238 may increase its processing power, amount of memory and number of networkable connections by incrementally adding and/or removing capacity as needed, balancing workload across multiple processors, multiple servers, dedicating specific processors and/or servers for performing specific tasks, using physical or logical servers (e.g., a multi-node cluster approach), etc.

As shown, the host server 238 includes one or more processing units (collectively “processor”) 240, memory 242, supports circuits 244 and bus 246. The processor 240 may be one or more conventional processors, microprocessors, multi-core processors, microcontrollers and the like.

The bus 246 provides for transmissions of digital information among the processor 240, memory 242 and support circuits 244 and other (not shown) portions of the host server 238. The support circuits 244 facilitate operation of the processor 240, and may include well-known circuitry or circuits, including, for example, one or more input/output I/O interfaces; one or more NIUs; cache; clock circuits; power supplies and the like.

The I/O interface provides an interface to control the transmissions of digital information among (shown and not shown) components of host server 238. In addition, the I/O interface provides an interface to control the transmissions of digital information among I/O devices 239 associated with or otherwise attached to the host server 238. The I/O devices 239 may be embodied as any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) a pointing device, such as a mouse, joystick, trackball, touchpad, pointing stick, light pen, head pointer, soap mouse, eye tracking devices, digitizing tablet and stylus, data glove that translates the user's movements to computer gestures; (vii) a key-in device, such as a keyboard or a touchpad, (viii) and the like.

The NIUs facilitate exchange (e.g., sending and/or receiving) of content. Accordingly, the NIUs may be adapted for communicating over terrestrial wireless, satellite, and/or wireline media.

The memory 242 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like. The memory 224 may store and/or receive requests from the processor 240 to execute various software packages, such as operating system 248, application-server software 250 and web-server software 252.

Additionally, the memory 242 may store and/or receive requests from the processor 240 to obtain the records 236.sub.i-236.sub.n (e.g., copies thereof). As above, each of the records 236.sub.i-236.sub.n may be stored as or in a single file or a plurality of files, and may be structured as text, a table, a database, a distributed hash table, a distributed concurrent object store, a document formed using a markup or markup-like language, and the like. The records 236.sub.i-236.sub.n may be stored, for example, using a Microsoft SQL Server and accessible through an ODBC connection.

Like the records 236.sub.i-236.sub.n, the memory 242 may store and/or receive requests from the processor 240 to obtain operands, operators, dimensional values, configurations, and other data that are used by the various software packages to control the operation of and/or to facilitate performing the functions of the host server 238 and/or the host 206.

The application-server software 250, when executed by the processor 240, is operable to (i) communicate with the data acquisition unit 212, via the network 216, to obtain the deposited-material record 236.sub.j; and determine a value associated with the deposited-material measure stored in the deposited-material record 236.sub.j. In addition, the application-server software 250, when executed by the processor 240, is operable to associate the value to a credit, which may be redeemable by the entity; post the credit to the credit to a user account associated with the entity (“entity account”); and provide the web-server software 252 with access to the entity account.

The web-server software 252, when executed by the processor 240, is operable provide on one or more web pages to allow the entity to access the entity account, and in turn, the credit and other information associated with the recycling activities. For example, web-server software 252 may post the credit on the web pages that are accessible to an entity via the user device 207 and entity account, so as to enable the entity to view details of the entity account. The details of the entity account may include the credit (and/or previously accrued credits) associated with the recycling activities of the deposited (and/or previously deposited) material, dates associated with the recycling activities, quantities of the deposited and (previously deposited) material recycled over a given period of time; debits from the credit (and/or previously accrued credits), detailed history of spending of the credit (and/or previously accrued credits), any orders for vouchers for redeemed credits, and the like.

In addition, the web-server software 252, when executed by the processor 240, is operable to allow the entity, via the user device 207, to redeem the credit. This may include the web-server software 252 providing a portal to retailers to allow the entity to redeem the credit (and/or previously accrued credits) at the retailers to obtain goods, services, coupons valued for goods or services, other benefits or discounts, and the like.

The web-server software 252 may also be operable to allow the entity to transform the credit (and/or previously accrued credits) into one or more vouchers that may be spent at the participating retailers or donated to some other entity. To facilitate this, the web-server software 252 includes code to allow the entity to (i) order the vouchers for delivery by mail, email or other communication medium; (i) provide information to the entity via the user device 207 to allow the entity to print or otherwise reduce to physical form, store it on the user device 207 or a peripheral device coupled to the user device 207 (e.g., a PDA, memory device, etc.).

The user device 207 may be, for example, any of or any combination of a personal computer; a portable computer, a handheld computer; a mobile phone, a digital assistant, a personal digital assistant, a cellular phone, a smart phone, a pager, a digital tablet, a laptop computer, an Internet appliance and the like. In general, the user device 207 may include a processor-based platform that operates on any suitable operating system, such as Microsoft® Windows®, Linux and/or Symbian; and that is capable of executing software.

The user device 207 may, however, include a large number of elements; many of which are not shown in FIG. 2 for simplicity of exposition. The user device 207 includes elements similar to the data acquisition unit 212, except as described herein below. The user device 207 may be formed in a single unitary device and concentrated on a single server, client, peer or other type node. Alternatively, the user device 207 may be formed from one or more separate devices, and as such, may be distributed among a number of server, client, peer or other type nodes. In addition, the user device 207 may be scalable.

As shown, the user device 207 may include a processing platform 209 that is operable to control, manipulate or otherwise interact with a monitor 211 and/or an I/O device 213, via respective couplings. The processing platform 209, the monitor 211 and the I/O device 213 include elements similar to or the same as the processing platform 218, the monitor 220 and the I/O device 222 of the data acquisition unit 212, and as such, the details of such elements are not reproduced here for simplicity of exposition.

The user device 207 is operable to form a user interface through which the entity can access the web pages provided by the web-server software 252. To facilitate this, the user interface may be communicatively coupled with the host server 238 via a network 216. The user interface may be, for example, a graphical-user interface that is operable execute a web browser application for rendering on the monitor 211 the web pages provided by the web-server software 252. As noted, the entity may use the user device 207 to access the users account, redeem credits and other like functions.

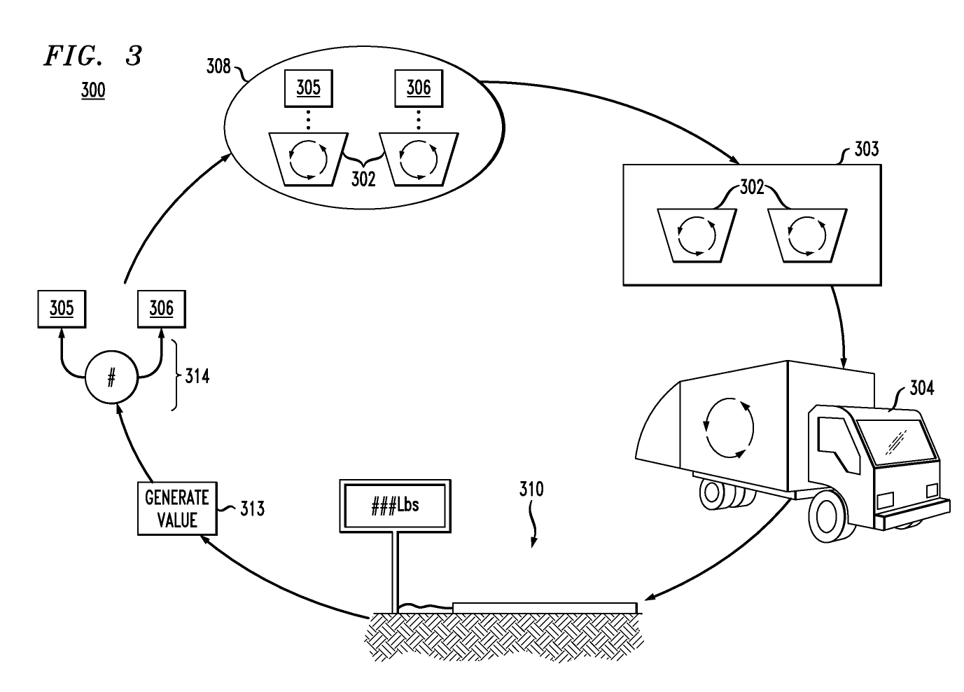

FIG. 3 depicts an exemplary recycling system, in accordance with one embodiment of the present invention. The system 300 generally comprises a first entity 305 and a second entity 306, within a community 308, each having a respective recycling container 302, and a collection vehicle 304, among other components, as discussed herein.

The first entity 305, which may also be referred to as a “first entity member,” may provide a quantity of recyclable materials. The recyclable materials may comprise one class of recyclable material (e.g., cardboard, paper, plastic, glass, aluminum, organic, or any other material not suitable for landfills), or optionally, a plurality of classes of recyclable material (e.g., a mixed composition of materials). The quantity of recyclable materials may be housed within a recycling container 302. A single class or mixed composition of materials may be housed within a single recycling container 302.

The recycling container 302 may include any container capable of housing recyclable material. Generally, the recycling container 302 will include a structure with an interior volume in which recyclable materials may be housed. In one embodiment, the recycling container 302 may include additional structural features such as a lifting bar with which a collection vehicle 304 can lift a recycling container 302 and collect its contents. Other optional features include a lid for protecting the interior volume from environmental elements and wheels for easy transport of the recycling container 302. Additional embodiments of the present invention may utilize any other type of container such as recycling bins, buckets, bags, or the like.

In general, the first entity 305 may be any entity that provides a quantity of recyclable material for collection. In one embodiment, the first entity 305 may be a resident of a township or municipality. In another embodiment, the first entity 305 may be an employee of a company, a student of an academic institution, a member of an organization, a resident in a neighborhood, or the like. The second entity 306 may include any collection of first entity 305 members. In many embodiments, the second entity 306 and the first entity 305 coexist in a community 308. In one embodiment, the community 308 may be a town or municipality. In another embodiment, the community 308 may be a neighborhood or apartment building. Alternative embodiments of the present invention may utilize the community 308 as any communal area, no matter how large (e.g., a country) or small (e.g., floor of an apartment building), wherein at least the first entity 305 and second entity 306 can be said to coexist within the community 308. As further understood by embodiments of the present invention, the community 308 may comprise any number of entities, and should not be considered limited to any minimum or maximum amount.

In one embodiment of the present invention, the first entity 305 and second entity 306 may each provide a quantity of recyclable material for pick-up by a collection vehicle 304. In some embodiments, the recycling containers of each of the first entity 305 and the second entity 306 may be emptied or placed into a community container 303 prior to pick-up. Such an exemplary embodiment may include scenarios where each tenant of an apartment building empties its recycling container into a large recycling dumpster, provided for the residents of the building. A community container 303 may comprise any containment device or apparatus suitable for embodiments of the present invention.

In accordance with embodiments of the present invention, a community container 303 generally comprises an identification means, for example, an identification tag, as discussed above.

In many embodiments, rather than provide a separable community container 303, the community container 303 may be provided as the storage space of a collection vehicle 304. For example, while providing a recycling dumpster outside an apartment complex may be convenient for residents of the apartment complex, one dumpster may not be a reasonable solution for residents of a neighborhood. In such an example, the collection vehicle 304 may also comprise the community container 303, whereas each of the residents of a neighborhood would collectively place their respective recyclable materials in the community container 303 during a pick-up. In certain embodiments of the present invention, a plurality of community containers may be provided in a single recycling system. Such plurality of community containers may include any combination of containment devices or apparatuses, in accordance with embodiments of the present invention.

The collection vehicle 304 may additionally comprise an array of devices and/or systems. For example, in one embodiment, the collection vehicle 304 may include a truck or automobile capable of driving a route to collect recyclable material. In another embodiment, the collection vehicle 304 may be a stand-alone kiosk in which recyclable material may be deposited by a first entity 305. In a further embodiment, the collection vehicle 304 may be a recycling processing center or drop-off center. The collection vehicle 304 may be located in a permanent, semi-permanent or temporary location.

An identification mechanism may be used to determine the identity of the first entity 305 and second entity 306, and to be given credit for contributing recyclable materials to the community container 303.

In one embodiment, the identification mechanism may include a RFID system comprising a RFID tag and RFID reader. In such an embodiment, the first entity 305 and the second entity 306 may each have a recycling container 302 with an active or passive RFID tag thereon. Generally, the RFID tag is unique to the corresponding first entity 305 or any entity account, and may be characterized as a unique identifier. A collection vehicle 304 may have a RFID reader that is capable of determining which entity provides recyclable material (i.e., based on the RFID tag read). In other embodiments, other identification mechanisms or systems (e.g., bar codes, magnetic strips, GPS and/or other location-based identification, biometrics and the like) may be utilized and are considered within the scope of the present invention.

In an alternative embodiment, identification may include the opening, registering or enabling an account with the recycling hauler and/or system administrator. For example, if all residents of an apartment building are registered with a recycling system administrator, in accordance with embodiments of the present invention, such registration may be sufficient for identification of all residents within the apartment building, for all pick-ups of the recyclable materials in the community container (i.e., recycling dumpster) outside the apartment building. Similarly, if residents of a neighborhood are registered with the recycling hauler to have their respective recyclable materials picked-up by the hauler, each registered resident may be identified as being associated with any recyclable materials collectively picked-up by a collection vehicle in that neighborhood, whether a registered resident actually contributed or not.

In certain embodiments, however, whereas each recycling container 302 may be provided with an identification tag, only entities which participate and contribute recyclable materials to the community container may be identified as a participating entity during a specific collection period by the collection vehicle. Such an embodiment may prevent certain non-participating registered entities from “coat-tailing” the environmentally-conscious efforts of others.

In one embodiment, a qualitative or quantitative measurement of the recyclable materials in a community container 303 is ascertained with measuring device 310. As shown in the exemplary system of FIG. 3, the measuring device 310 may comprise a scale. In such an embodiment, the weight of the recyclable materials may be ascertained by obtaining a tare weight of the collection vehicle (i.e., weighing the collection vehicle 304 prior to unloading the recyclable materials and subtracting a known weight or measured weight of the collection vehicle 304). In another embodiment, the recyclable materials are directly unloaded onto on a scale or other weighing means (e.g., any aspect of the load determining device discussed above). Alternative embodiments of the present invention provide any qualitative or quantitative measurement may be suitable. For example, a measurement of volume, mass, density, quality, composition, or the like, may be a suitable measurement for embodiments of the present invention.

In another embodiment, the recyclable material may be measured prior to collection by a collection vehicle 304. In such an embodiment, the collection vehicle 304 may be provided with a means to individually measure collected recyclable material, as it is collected from respective recycling containers 302 and/or community containers 303, despite the eventual mixture of all the recyclable materials from all sources in the collection vehicle 304 upon completion of a collection route.

Once a measurement of the recyclable material or collective material is obtained, the measurement may be converted into a value 313, in accordance with embodiments of the present invention. The value 313 associated with the measurement may be financial (e.g., monetary or economic). For example, the value 313 may be based, at least in part, on an amount of the measurement. Alternatively, the value 313 may be based, at least in part, upon financial offerings of one of more retailers participating in a rewards program (“participating retailers”). The value 313 may have a minimum and/or a maximum. The maximum may be based on time (e.g., no more than “x” for a given period of time). To facilitate determining the value 313, a computer system may employ database software, like that shown in FIG. 2, along with a database and algorithms that form one or more models for assigning the value to the measurement.

In an exemplary embodiment, the value 313 may be assigned by the fact any entity participated in the recycling program, by registering an account or otherwise, regardless of the amount of recyclable materials contributed. In another exemplary embodiment, the value 313 may be assigned correlating to an amount in a community container 303 in a given period of time. In such an embodiment, the value 313 associated with each entity in the community 308 (i.e., the reward 314) may be calculated by obtaining an overall value 313 and dividing it by the number of entities within the community 308, or limited to those associated with contributing recyclable materials. In other embodiments, each entity may receive a set percentage of the overall value 313 (e.g., 2%, 5%, etc.). Depending on the architecture in place within the system, embodiments of the present invention may limit rewards to only those who contribute recyclable materials (i.e., if contributing entities are separably identifiable in a given period). For example, during a neighborhood collection route, if eight (8) of twelve (12) registered residents contribute recyclable materials during a specific collection period, and each of the eight contributing residents can be identified because of the identification tag on its recycling container, only those eight contributing residents would be credited with a reward.

Alternative exemplary embodiments contemplate combinations of the above, as well as similar predetermined algorithms. The database software in combination with the database and algorithms may provide flexibility in applying different rates for determining the value. These rates may differ based on availability of the financial offerings, the type of entity, geographic area of the entity, and other demographics. The rates may be applied so that the entities receive an optimum incentive to for recycling the recyclable materials. Co-owned United States Patent Application Publication No. 2008/0059970 provides a more detailed description of general reward generation and allocation, the disclosure of which is incorporated by reference in its entirety.

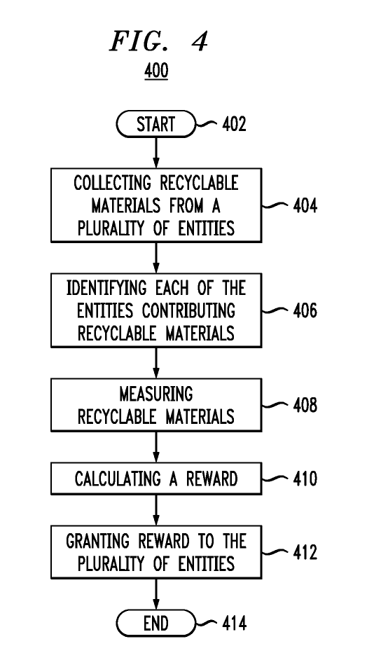

FIG. 4 is a block diagram of the method of recycling in accordance with one embodiment of the present invention. Generally, methods in accordance with embodiments of the present invention utilize an incentive-based recycling system as disclosed and discussed above with respect to either of FIG. 2 or 3. For convenience, the block diagram of the method of recycling 400 is described with reference to the recycling system 300 of FIG. 3. It is understood, the block diagram of the method of recycling 400 may be carried out using other architectures as well.

It should be noted that any process descriptions or blocks in flow diagrams should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

The method of recycling 400 begins at step 402. At step 404, a quantity of recyclable material is collected. In general, a quantity of recyclable material may be provided by a first entity 305 and a second entity 306. Generally, the recyclable materials may be collected from respective recycling containers 302 of each of the entities. In most embodiments, the recycling containers 302 comprise an identification tag for identifying the entity. In certain embodiments, individual recycling containers may be emptied into a community container 303, for ease of pick-up. In such embodiments, the community container 303 may comprise identification data for identifying each entity permitted to utilize the community container 303.

A collection vehicle 304 may comprise a truck, which may drive a pre-determined route within a community 308 (e.g., a neighborhood) and collect the recyclable material within recycling containers 302. In many embodiments, during predetermined periodic intervals, a recycling container 302 of each entity within a community 308, is placed in a designated pick-up location. In one embodiment, the designated location is along a curbside adjacent to a residence of each entity. In another embodiment, the designated location for each entity is a community container 303.

At step 406, at least a first entity 305 is identified. In accordance with one embodiment of the present invention, recyclable materials are placed in a recycling container 302 by a first entity 305, in which the recycling container 302 is identifiable with the corresponding first entity 305 with an identification mechanism. The identification mechanism may include an identification tag. For example, one type of identification tag may be a passive RFID tag located on an outer surface of the recycling container 302. A collection vehicle 304 may have a RFID reader that may read the RFID tag on the recycling container 302, thereby identifying the entity information corresponding to the recycling container 302. A specific identification tag that corresponds to the identification of a first entity 305 may be considered by one having skill in the art as a unique identifier. In the above-stated embodiment, the identification tag is depicted as a passive-RFID tag. However, in alternative embodiments, the identification tag may comprise an active RFID tag, a barcode, textual identification information or the like. The identification tag is generally positioned on an outer surface of the recycling container 302, such that it is readily accessible without having to move or lift the recycling cart.

In one embodiment of the present invention, the unique identifier of the first entity 305 may be entered into a database for information processing and/or recording, using systems and methods disclosed herein. The identity of the first entity 305 may be processed or recorded as having provided recyclable materials during a collection period. In one embodiment, the database is provided with a means for duplication prevention, such that the database can identify and remove duplicate unique identifier entries. In such an embodiment, executable software or additional code in the database may be utilized as the means for duplication prevention.

At step 408, a qualitative or quantitative measurement of recyclable material is obtained using measuring device 310. Generally, the measurement of the quantity of recyclable materials will be a measurement of weight. However, other processes of measuring the recyclable material may also be available and may include, for example, a measurement of volume, mass, quantity, or the like.

In accordance with one embodiment of the present invention, after the collection vehicle 304 has collected a quantity of recyclable material, it may be unloaded at a recycling facility. At the recycling facility, a qualitative or quantitative measurement (e.g., weight) of the recyclable materials is ascertained. In one embodiment, a weight of the recyclable materials is ascertained by obtaining a tare weight of the collection vehicle 304.

In another embodiment, a measurement of the recyclable material may be obtained as the recyclable material is collected from each of the community containers 303. In such an embodiment, a collection vehicle 304 may include a load determining device that weighs the recyclable material housed within the community container 303 as it is collected.

At step 410, a reward is calculated. Generally, a reward is associated with a value corresponding to a measurement of recyclable materials collected during a predetermined interval or from a specific source. In one embodiment of the present invention, the rewards are monetary rewards (e.g., cash, gift certificates, coupons for value, tickets, and the like). In another embodiment of the present invention, the rewards are based upon a points system, wherein points are redeemable for goods/services of at least a vendor (e.g., a coffee shop, clothing store, etc.).

In accordance with many embodiments of the present invention, a reward may be calculated by dividing the gross value associated with the gross measurement of the recyclable materials, by a number of entities providing recyclable materials, such that each entity may receive an equal reward. In some embodiments, for example, where a community container 303 is utilized outside a housing complex (e.g., an apartment building), it may be difficult to ascertain specifically which entities deposited recyclable materials into the community container 303. In such an example, each entity permitted to deposit recyclable materials in the community container 303 may receive a reward for the value of the quantity of recyclable materials, whether every entity participated or not. Combinations of these concepts may be implemented as well. For example, in a community 308 comprising a plurality of residential entities and an apartment complex having its own community container for the residents therein, each of the plurality of residential entities and each of the residents of the apartment complex permitted to deposit recyclable materials in the community container, may all equally receive a reward based on the value of the overall collection from the community 308.

At step 412, the reward is granted. In many embodiments, each of the entities associated with the recycling system 300 may be required to maintain an account in a database hosted by a system administrator. In such embodiments, the reward may be granted by depositing the reward value (i.e., points, money, etc.) into the entity's account.

The method of recycling 400 ends at step 414. However, alternative embodiments of the present invention may provide for additional features or steps, or a combination thereof, within broad scope of the method of recycling 400.

In accordance with one embodiment of the present invention, information associated with the method of recycling 400 may be recorded and/or transmitted via a global computer network, to a centralized location (e.g., a server). In such an embodiment, information associated with the method of recycling 400 may be accessible to a first entity 305, a second entity 306, or another individual via the Internet. In other embodiments, the method of recycling 400 is adaptable and scalable by uploading data to a central server and storing entity information, identification information and rewards information. In one embodiment, a plurality of collection vehicles 304 and collection routes may be monitored from one system database or a central headquarter location.

Additionally, embodiments of the present invention contemplate the remote transmission of any data associated with the recycling system 300 or the method of recycling 400 disclosed herein through any known communication means and between any two capable mediums. For example, connectivity to an upload station for storing entity information in a database may be included. In one embodiment, the connectivity may be via a wireless local area network connection. Other embodiments may provide connectivity via a standard communication protocol.

It should be emphasized that the above-described embodiments of the present invention are merely possible examples of implementations, merely set forth for a clear understanding of the principles of the invention. Many variations and modifications may be made to the above-described embodiments) of the invention without departing substantially from the spirit and principles of the invention. All such modifications and variations are intended to be included herein within the scope of this disclosure and the present invention and protected by the following claims.

What is claimed:

1. A community-based recycling system comprising:
a first entity, providing recyclable material;
a second entity, providing recyclable material;
a load determining device for obtaining a qualitative or quantitative measurement of the recyclable material accumulated from both the first entity and the second entity; and
a reward granted equally to each of the first entity and the second entity;
wherein the reward corresponds to a value generated from the measurement of the recyclable material.

2. The system of claim 1, further comprising an identification means for obtaining information of both the first entity and the second entity.

3. The system of claim 2, wherein the identification means further comprises an RFID tag and reader assembly.

4. The system of claim 1, wherein the first entity comprises a recycling container having an identification tag, and wherein the recyclable material is provided within the recycling container.

5. The system of claim 1, further comprising a computer network operable to transfer data from the load determining device to a central database.

6. The system of claim 1, wherein the load determining device is positioned on a collection vehicle.

7. The system of claim 1, wherein the qualitative or quantitative measurement of the recyclable material comprises at least one of a weight, volume, density, quality, or composition.

8. The system of claim 1, wherein the first entity and the second entity each provide the respective recyclable materials to a community container.

9. A recycling system comprising:
a first entity, providing a quantity of recyclable materials;
a second entity, providing a quantity of recyclable materials;
a community container for supporting a quantity of recyclable materials received from the first and second entities;
a collection vehicle for collecting recyclable materials from the first and second entities, comprising a load determining device for obtaining at least a weight or volume of the recyclable materials, and an identification means; and
a reward granted equally to each of the first entity and the second entity;
wherein the reward corresponds to a value generated from the weight or volume of the recyclable material.

10. The system of claim 9, wherein the identification means further comprises an RFID tag and reader assembly.

11. The system of claim 10, wherein the RFID tag is positioned on the community container, and wherein the RFID reader is positioned on the collection vehicle.

12. The system of claim 9, further comprising a computer network operable to transfer data from at least one of the load determining device or identification means to a central database.

13. The system of claim 12, wherein the reward is granted to a respective account associated with each of the first and second entities, stored on the central database.

14. The system of claim 13, wherein the respective rewards are redeemable by the first and second entities by accessing the respective accounts on the central database via the communication network.

15. A community-based method of recycling comprising:
collecting recyclable material from an identifiable first entity;
collecting recyclable material from an identifiable second entity;
obtaining a qualitative or quantitative measurement of cumulative recyclable materials collected from both the first and second entities;
calculating a value associated with the qualitative or quantitative measurement of cumulative recyclable materials; and
granting a reward to the first and second entities based on the value.

16. The method of claim 15, wherein the first entity is identifiable via an RFID tag on a recycling container.

17. The method of claim 15, further comprising dispatching a collection vehicle on a predetermined route.

18. The method of claim 15, further comprising transferring data associated with the qualitative or quantitative measurement of cumulative recyclable materials to a central database.

19. The method of claim 18, wherein granting the reward to the first and second entities comprises crediting respective accounts associated with each of the first and second entities, stored on a central database.

20. The method of claim 19, further comprising providing a means for redeeming the respective rewards by the first and second entities by accessing the respective accounts on the central database via the communication network.
